(19) United States
(12) Patent Application Publication
(10) Pub. No.: US 2015/0193226 A1
(43) Pub. Date: Jul. 9, 2015

(54) INSTRUMENTATION AGENT FOR MANIPULATING COMPONENT RESPONSES

(71) Applicant: John J. Michelsen, Irving, TX (US)

(72) Inventor: John J. Michelsen, Irving, TX (US)

(73) Assignee: Interactive TKO, Inc., Plano, TX (US)

(21) Appl. No.: 13/206,877

(22) Filed: Aug. 10, 2011

(51) Int. Cl. G06F 9/54; G06F 9/44

(52) U.S. Cl. CPC G06F 8/67; G06F 8/70

(57) ABSTRACT

A first software agent is used to intercept first data sent to a first software component from a second software component, each of the first and second software components included in a plurality of software components that are included in the particular software system. The first agent is used to determine that a particular value of the intercepted first data is different from one or more preferred values for the first data. Substitute data having a preferred value is passed to the first software component in lieu of the intercepted data.

### TECHNICAL FIELD

This disclosure relates in general to the field of computer systems management and, more particularly software component agents.

### BACKGROUND

Typically, agents embedded in software components serve a non-invasive role, monitoring and collecting information from software components without affecting the operation or functions of the software component themselves. For instance, software agents have been described in U.S. patent application Ser. No. 11/328,510, titled “Instrumentation System and Method for Testing Software,” filed Jan. 9, 2006, to John J. Michelsen and U.S. patent application Ser. No. 13/155,363, titled “Modeling and Testing of Interactions Between Components of a Software System,” filed Jun. 7, 2011, to John J. Michelsen, et al.

### SUMMARY

In general, one aspect of the subject matter described in this specification can be embodied in methods that include the actions of intercepting, using a first agent, first data sent to a first software component from a second software component, each of the first and second software components included in a plurality of software components that are included in a particular software system. It can be determined, at the first agent, that a particular value of the intercepted first data is different from one or more preferred values for the first data. Substitute first data having a preferred value can be passed to the first software component in lieu of the intercepted first data.

In another general aspect of the subject matter described in this specification can be embodied in systems that include a memory element storing data, a processor operable to execute instructions associated with the stored data, at least one first software component interacting with at least one other software component in a software system, and at least one agent. The agent can be configured to intercept particular data sent to the first software component from at least one other software component, determine that a particular value of the intercepted particular data is different from one or more preferred values for the particular data, and pass substitute data having a preferred value to the first software component in lieu of the intercepted particular data.

These and other embodiments can each optionally include one or more of the following features. The first data can be intercepted during live operation of the particular software system. The first data can be sent to the first software component from the second software component in connection with the particular software system providing a particular service to a consumer. The first agent can interface with the first software component and intercept the first data before the first data is received by the first software component. The first agent can interface with the second software component and intercept the first data before the first data is sent to the first software component from the second software component. The first software component can use the substitute first data to generate additional data for use in a service provided to a consumer. The particular software system can be a composite software system and the first software component can be an element of a first software system and the second software component can be an element of a distinct, second software system. The substitute first data can be generated at the first agent in response to determining that the particular value is different from the one or more preferred values. The substitute first data can be generated based on monitored interactions between the first and second software components. The first software component can generate a first result in response to the first data having the particular value and generates a second, different result in response to the substitute first data. Determining that the particular value is different from the one or more preferred values can include determining that the particular value corresponds to an error message.

Further, embodiments can each optionally include one or more of the following additional features. Risk can be evaluated associated with replacing the intercepted first data with the substitute first data. The risk can be associated with a business exception. The first agent can be used to log the interception of first data with the particular value. The first agent can be used to log the passing of the substitute first data in lieu of the intercepted first data. Second sent to the first software component from the second software component can be intercepted using the first agent. It can be determined, at the first agent, that a value of the intercepted second data conforms to one or more preferred values for the second data. The intercepted second data can be passed to the first software component for use by the first software component. The software system can serve a composite application using the first software component and at least one other software component. The particular data can be sent to the first software component from at least one other software component in connection with the delivery of a service to a customer.

### DESCRIPTION OF DRAWINGS

FIG. 1 illustrates an example system including instrumentation agents.

FIG. 2 is a schematic representation of example software systems including instrumentation agents.

FIG. 3 is a flowchart of an example technique for using instrumentation agents to modify software component messages.

FIGS. 4A-4B illustrate representations of examples of using instrumentation agents to modify incoming software component responses.

FIGS. 5A-5B illustrate representations of examples of using instrumentation agents to modify outgoing software component responses.

Like reference symbols in the various drawings indicate like elements.

### DETAILED DESCRIPTION

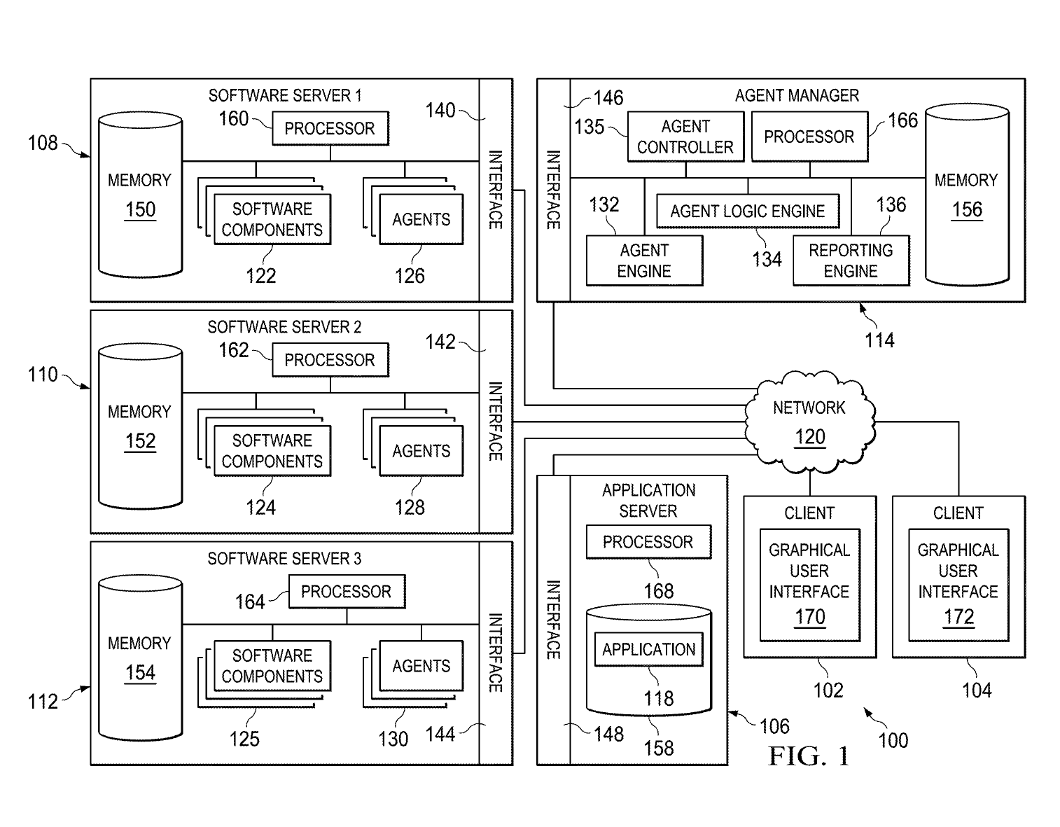

FIG. 1 illustrates a computing system 100 including, or communicably coupled with, one or more clients 102, 104, one or more applications (or application development) servers (e.g., 106), and other computing devices, such as servers 108, 110, 112 serving one or more software components (e.g., 122, 124, 125), such as applets, databases, applications, services, managers, enterprise software modules, and other components. Such components can be used, for example, in connection with a composite software application or system. Additionally, one or more agent manager servers 114 can be provided to provide support and manage one or more instrumentation agents (or “agents”) (e.g., 126, 128, 130) interfacing with software components served by the one or more software servers 108, 110, 112. Computing devices 102-114 can be communicably via one or more networks 120.

In general, each of “servers” 106, 108, 110, 112, 114 can include electronic computing devices operable to receive, transmit, process, store, or manage data and information associated with the software system 100. As used in this document, the term “computer” or “computing device” is intended to encompass any suitable processing device. For example, the system 100 may be implemented using computers other than servers, including server pools, as well as virtual devices and computers provisioned in a cloud computing environment. Further, any, all, or some of the servers 106, 108, 110, 112, 114 may be adapted to execute any operating system, including Linux, UNIX, Windows Server, etc., as well as virtual machines adapted to virtualize execution of a particular operating system, including customized and proprietary operating systems.

Servers 106, 108, 110, 112, 114 and other computing devices (e.g., 102, 104) in system 100 can each include one or more interfaces (e.g., 140, 142, 144, 146, 148), computer-readable memory (e.g., 150, 152, 154, 156, 158), and one or more processors (e.g., 160, 162, 164, 166, 168). Each server can further include code that creates an execution environment for the computer program in question, such as an operating system, or one or more virtual machines. Additional software modules, applications, simulators, and functionality can also be executed on servers 106, 108, 110, 112, 114.

In some instances, certain software resources, services, applications, data structures, and other components can be used to deliver a particular service to one or more clients (e.g., 102, 104) and service consumers, including other application servers (e.g., 106). Indeed, some modern software systems deliver such services and applications using composite software system architectures made-up of a plurality of different software components (e.g., 122, 124, 125), including combinations of software components served by multiple different server devices (e.g., 108, 110, 112) and vendors. Various software components can interface with and execute in cooperation with other software components. Further, some software components can be “out-of-the-box,” “plug-and-play,” “modular,” or otherwise reusable software components capable of being used and re-used in connection with multiple other software components and within multiple different software systems and applications. Agents (e.g., 126, 128, 130) can be provided for use in connection with certain software components to assist in customizing and adding logic to the software components. For instance, agents can be added to interface with or be embedded within software components to enhance the functionality of a system or software component with business exception or risk modeling logic. Agents can provide such functionality, for instance, by intercepting messaging between two different software components and modifying the messaging according to particular logic to influence the performance of a software component receiving the message(s) or other data and dependent on the software component sending the message(s)/data.

In addition to the provision of agents interfacing with software components of a system, an agent manager server 114 can be provided to manage the provision, use, updating, and monitoring of agents (e.g., 126, 128, 130) deployed in a system 100. One or more agent managers 114 can be provided, such as a centralized agent manager system managing a plurality of agents deployed in a plurality of varied and distinct software systems, agent managers responsible for agents deployed in a single system, as well as agent managers managing agents deployed within systems of a particular enterprise or other entity. Agent manager 114 can include one or more processor devices (e.g., 166) and memory elements (e.g., 156) and include an agent engine 132, agent logic engine 134, agent controller 135, and agent reporting engine 136.

An agent engine 132 can be provided, adapted to serve, integrate, interface, embed, or otherwise launch agents on corresponding software components. Further, agent engine 132 can generate an agent, in connection with agent logic engine 134, customized for use with a particular software component. Agent logic engine 134 can also be used to periodically, and automatically, update the logic of a particular agent executing in connection with a particular software component. In some instances, agent engine 132 can generate a particular agent instrumented to monitor and handle messaging between a particular software component and one other software component. The agent engine 132 (and/or agent logic engine 134) can automatically, or dynamically, generate an agent based on one or more models generated through monitoring of interactions and messaging between the two software components. In some instances, generation of an agent can be based on a virtual service model itself generated by capturing and recording live, simulated, or virtualized traffic between the two or more software components. In one example, such a virtual service model can be based on concepts described, for example, in U.S. patent application Ser. No. 12/242,783 to John J. Michelsen (filed Sep. 30, 2008), incorporated herein by reference in its entirety as if completely and fully set forth herein.

Agents can conditionally monitor and modify messages transmitted between one or more software components. For instance, a software system can itself execute or operate within one or more different contexts. For instance, a software system can be executed within a test environment or context, live or production context or environment, as well as other, more-specified environments, contexts, or conditions based, for example, on time of day, week, month, or year, number of users, connectivity status, etc. Accordingly, agents can be configured to be active, on, or otherwise functioning, within, or in response to, certain contexts of a corresponding software component or system. Additionally, agents may execute differently, or according to different logic paths, depending upon an identified context of operation. For instance, a single agent, interfacing with a particular software component, can be used to assist in monitoring and controlling operation of the particular software component within a test environment (i.e., in a first context) and alternatively be used to provide supplementary functionality and/or exception modeling within live, or actual production use of the same software component (i.e., in a second context). Further, an agent controller 135 can be used to drive or dictate operation of one or more agents deployed in a system, as well as provide logic to the agents themselves for use in controlling operation of the agents. Further, agent controller 135 can be used to provide functionality for agents to synchronize with the operations of the software components and transactions they monitor, whether in a live or pre-production environment.

Agent manager 114 can additionally include reporting engine 136 for use in tracking and reporting the operation and involvement of agents in transactions of the software system (e.g., 100). For instance, agents can intercept and manipulate messages and other data exchanged between software components. Data describing the agents' involvement can be collected indicating when, and under what conditions an agent has intervened in a particular transaction, including how the agent intervened (e.g., modified messages or data sent by a software component). Such data can be collected to generate reports and other data for use in analyzing the performance of one or more of the software components involved in particular transactions or types of transactions, as well as the performance of the agent itself. Reporting engine 136 can further generate and calculate statistical data and reports based on the collected data to assist in illustrating how often an agent intervenes within a system and under what conditions. Reporting data collected by reporting engine 136 can further be used to fine tune the logic of the agents, as well as models upon which the agent logic is based. For instance, statistical data collected by the reporting engine 136 can indicate that a particular agent intervenes too seldom, too often, or under unacceptable conditions, among other examples. Such data can be used by administrators, or by the agent manager 114 itself (e.g., using agent engine 132 and/or agent logic engine 134) to modify the logic of one or more agents to align them more with the goals or models of the agent.

Agents (e.g., 126, 128, 130) can be software-based agents configured to interface with a wide variety of different software components. Agents 126, 128, 130 can synchronize with transactions of a monitored software component to identify and detect data sent and/or received from a particular software component. Further, in some instances, agents 126, 128, 130 can further intercept data sent or received by a corresponding software component and analyze, apply logic to, and act on intercepted data, for instance, to modify the intercepted data to change the substance of the data in advance of processing of the data by a software component. Agents can be multi-functional and, in some instance, also provide visibility into the operations of each instrumented software component (such as in connection with a test or analysis of a software component). Further, agents 126, 128, 130 can be configured to generate information about the detected or intercepted requests and/or responses and to report that information to other software entities, including agent manager 114. Further, actions taken by an agent on intercepted data can also result in information being generated, for instance, documenting the action taken. Additionally, agents 126, 128, 130 can also be configured to detect and report on activity that occurs internally within a corresponding component, such as within a component in which an instrumentation agent is embedded.

In some examples, instrumentation agents can be implemented by inserting a few lines of code into the corresponding software component (or the application server associated with that software component) being instrumented. Such code can be inserted, for example, into a servlet filter, SOAP filter, a web service handler, an EJB3 method call, a call to a Java Database Connectivity (JDBC) handler, among other examples. For instance, an instrumentation agent configured to monitor an EJB can be configured as an EJB3 entity listener (e.g., to monitor entity beans) or interceptor (e.g., to monitor session beans). In one embodiment, instrumentation agents can include additional functionality similar to that described, for example, in U.S. patent application Ser. No. 11/328,510, titled “Instrumentation System and Method for Testing Software,” filed Jan. 9, 2006, and listing John J. Michelsen as an inventor, which is hereby incorporated by reference in its entirety as if completely and fully set forth herein.

Some components (or their corresponding application servers) may not provide users with the ability to modify their code, and thus some instrumentation agents can be implemented externally to the component being monitored in a manner that will cause all requests and responses being sent to and/or from that component to be handled and, in some cases, intercepted by the agents. For example, for an existing database, an agent can be implemented as a driver. Calling components can be configured (e.g., by manipulating a driver manager) to call the instrumentation driver instead of the database's driver. The instrumentation driver can in turn call the database's driver and cause the database's driver to return responses to the instrumentation driver. For example, in one embodiment, the identity of the ‘real’ driver for the database can be embedded in the uniform resource locator (URL) that is passed to the instrumentation driver. In this way, the instrumentation driver can intercept all calls to the database, detect characteristics of those calls, pass the calls to the appropriate database, detect characteristics of the corresponding responses, and then return the characteristics of those calls and responses to an agent manager (e.g., 114).

In some embodiments, agents can be configured to perform interception and/or inspection (e.g., as provided by the Java™ Virtual Machine Tool Interface, or JVM TI). Such an instrumentation agent can register with the appropriate application programming agent (API) associated with the component or process being monitored in order to be notified when entry and/or exit points occur. This allows the instrumentation agent to detect requests and responses, as well as the characteristics of those responses. In particular, this functionality can allow an agent to detect when a component begins reading and/or writing from and/or to a socket, to track how much data is accessed (e.g., read or written), obtain a copy of the data so read or written, and generate timing information (as well as information describing any other desired characteristics) describing the time at which the data was read or written.

Some agents are configured to monitor individual threads by monitoring the storage used by each thread (i.e., the thread local storage for that thread). Such agents can detect when the monitored thread begins reading or writing to a thread local variable in the thread local storage. In response to detecting this access to the thread local variable, the agent can track the amount (e.g., in bytes, as tracked by incrementing a counter) of data that has been accessed, as well as the starting offset within the thread local storage to which the access takes place. In response to detecting that the thread's access to the thread local variable has ended, the agent can use the information about the access to identify characteristics such as the time of the access, the variable being accessed, the value being accessed, among other examples.

Application servers (e.g., 106) can include any suitable software component or module, or computing device(s) capable of hosting and/or serving a software application (e.g., 118), including distributed, enterprise, or cloud-based software applications. For instance, application servers can be configured to host, serve, or otherwise manage web services or applications (e.g., 118), such as SOA-based or enterprise web services, or applications interfacing, coordinating with, or dependent on other enterprise services. Applications and services (e.g., 118) provided through application servers 106 can further include web services under development. In some instances, some combination of one or more of application servers 106 can be hosted on a common computing system, server, or server pool, and share computing resources, including shared memory, processors, and interfaces, such as in an enterprise software system serving services to a plurality of distinct clients and customers. In some instances, application server 106 can consume resources served by other servers (e.g., 108, 110, 112, 114) in the system. For instance, an application server can consume a service served using one or more of software servers 108, 110, 112.

The illustrated implementation of FIG. 1 further includes one or more local and/or remote clients 102, 104. A client 102, 104 can be any computing device operable to connect or communicate at least with an application or other service (such as served by any one or more of servers 106, 108, 110, 112, 114) over network 120, using a wireline or wireless connection. Indeed, clients 102, 104 can also execute services, applications, and resources locally, including software components interfacing with instrumentation agents. Further, each client 102, 104 can include at least one graphical display device and user interfaces (e.g., 170, 172), allowing a user to view and interact with graphical user interfaces of test management software. Such graphical user interfaces can include interfaces for use in launching a test, providing instructions and parameters for a test, editing or otherwise modifying a test, viewing details and progress of a test, viewing health of the test system, viewing the provisioning of hardware resources for a test, etc. In general, the client 102, 104 can include any electronic computing device operable to receive, transmit, process, and store any appropriate data associated with the software environment of FIG. 1. It will be understood that there may be any number of clients 102, 104 associated with system 100, as well as any number of clients 102, 104 external to system 100. Further, the term “client” and “user” may be used interchangeably as appropriate without departing from the scope of this disclosure. Moreover, while each client 102, 104 is described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

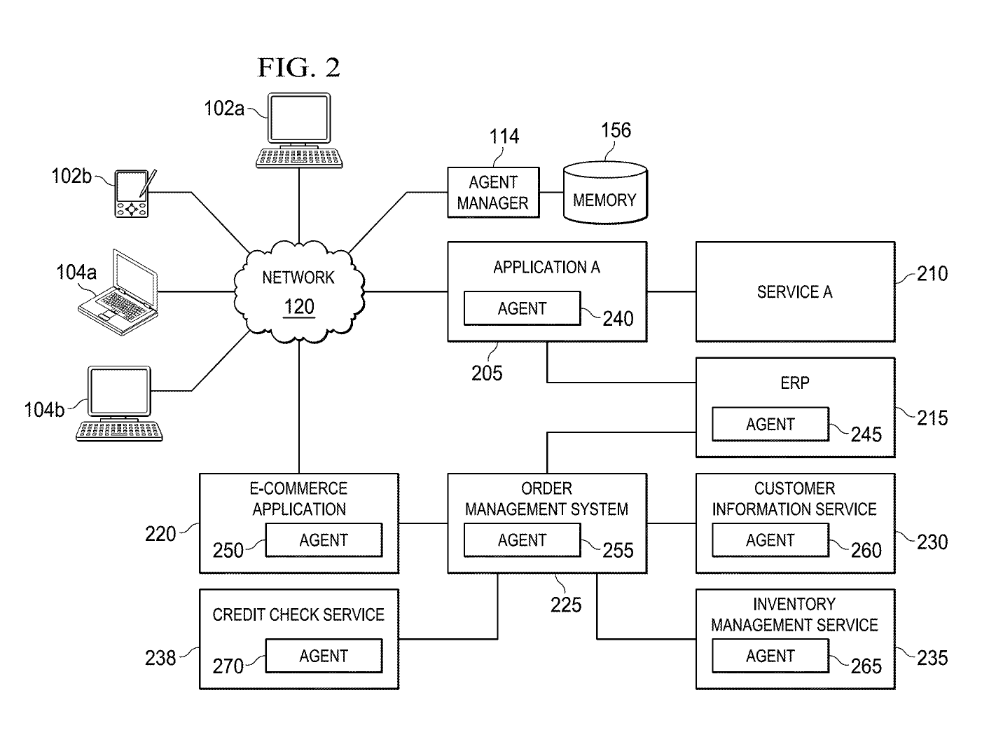

Turning now to FIG. 2, a schematic representation of example software systems including instrumentation agents. In one example, a plurality of web-based applications 205, 220 are available for consumption over one or more networks 120, including, for example, the Internet, by one or more client computing devices (e.g., 102a, 102b, 104a, 104b). Some of the software components 205, 215, 220, 225, 230, 235, 238 including the software components (e.g., 205, 220) serving the applications on the network 120, can include agents (e.g., 240, 245, 250, 255, 260, 265, 270) interfacing with the software components (e.g., 205, 215, 220, 225, 230, 235, 238 respectively). Other software components involved in the system may lack an agent, such as software component 210.

In one particular example, an e-commerce application 220 can be used, for example, by an online retailer to take and process orders for goods and services offered by the retailer over the Internet. The e-commerce application 220 can be implemented as a composite system making use of a plurality of software components including an order management system (OMS) software component 225, which itself consumes an customer information service software component 230, inventory management service software component 235, credit check service component 238, and enterprise resource planning (ERP) service software component 215, among potentially other software components. In some instances, one or more software components can be re-usable and/or semi-customizable software components, such as re-usable software components provided by one or more enterprise and service-oriented software vendors. For instance, in the example of FIG. 2, deployments of a common, re-usable ERP service software component 215 can be used in connection with both application A 205 and e-commerce application 220. Further, a composite software system can include software components from a plurality of sources and vendors.

In the example e-commerce application 220, e-commerce application server 220 can interact with one or more other software components, for example, in response to a request received, for example, from client 102a, to place an order for a particular good. In connection with processing of the request, e-commerce application server 220 can exchange messages with OMS 225. OMS 225, in turn, can exchange messages with one or more of customer information service software component 230, inventory management service software component 235, ERP service software component 215, among other components, in connection with responding to the service request of e-commerce application 220. In some instances, two or more of software components 215, 220, 225, 230, 235, 238 can be provided by third-party service providers.

Even when some software components are managed, maintained, and/or developed by a single entity or enterprise, there may be imperfect knowledge bridging the variety of interfaces between the software components. For instance, while OMS 225 may include logic enabling OMS 225 to handle certain messages and outputs received by one or more of software components 205, 215, 230, 235, 238, OMS 225 may lack functionality to handle, at least in a desirable way, some potential outputs of these other software components 205, 215, 230, 235, 238. For instance, obscure, proprietary, unexpected, or otherwise unknown error codes, or other data can be received by OMS 225 from a particular software component. OMS 225 may have default logic for handling such unknown or unexpected outputs, although generic responses to such outputs may not be desirable.

Further, in some instances, customized exception handling features and logic may be desirable to add to certain systems to intervene against downstream dependencies (e.g., other software components) triggering, prompting, or otherwise causing negative, overly-conservative, inconvenient, incorrect, or otherwise undesirable results from being generated at software components. Such features may be desirable to add following deployment of the system, such as in response to errors, inefficiencies, and other issues identified in the system post-deployment. Accordingly, in some examples, agents can be added to interface with software components of a system to introduce specialized exception handling and risk analysis features based on business goals, risk calculus, and other models. As an example, in connection with the sale of a particular good using an example e-commerce application 220, the credit-worthiness or credit status of a particular online customer may be checked before processing payment. One or more credit check services 238 can be accessed to provide this service. Corresponding messages may be exchanged between e-commerce application 220, OMS 225, and a credit check service 238 in connection with such transactions.

Continuing with this illustrative example, in some instances, it is possible that credit check service 238 may be unable to respond satisfactorily (or as expected by other software components (e.g., 220, 225)) to a credit check request. For example, credit check service 238 may be unable to respond in the event of an outage or other technical difficulties plaguing the credit check service 238 at the time of the request. In such an instance, the credit check service 238 might normally respond with an error or other message communicating the outage or delay to the OMS 225. Unfortunately, technical difficulties at the credit check service 238 can result in the risk that a corresponding customer's transaction with e-commerce application 220 will not be completed, that the user experience will suffer, etc., resulting, in some cases, in the customer's business being lost or losing the customer to a rival service provider or retailer.

To mitigate against undesirable results from a set of sub-component or components of a system, or a composite application making use of a component, it can be desirable to alter the logic of the system, or one or more components of the system, using instrumentation agents. Such agents can provide logic for intervening within a system transaction when certain conditions are met. Such conditions can be built upon exception rules or models, as well as risk calculi. For example, in the example of the e-commerce application 220, there is a risk of losing sales and customers due to a failure to successfully process a user's purchase request. Such failures can result from a number of different causes and variable at any one of the software component in the composite system. For instance, as discussed in the example above, an outage or system error downstream at credit check service 238 can result in a customer transaction being cancelled or delayed. The credit check service 238, however, serves to mitigate against a contrary risk, namely, the risk of non-payment by the customer. Such risks, however, can be balanced to adopt exception handling rules, for instance, to override an outage or error at the credit check service 238. Accordingly, in some instances, an agent can be equipped with risk analysis or business exception logic that can be used to calculate the risk of proceeding in a given set of circumstances, allowing the agent to intervene and prevent the sale from being cancelled in instances where the risk of non-payment (for example) is deemed acceptable given the risk of losing the business of a particular customer. For instance, if a user is identified as a favored, repeat, or recent customer, or a customer for whom a credit check has recently been performed, a transaction may proceed despite an outage at the credit check service 238.

Other factors and risks can also be considered beyond those discussed in the example above. Further, analogous risk analysis and business exception logic can be adopted for a limitless array of different software components, systems, and use cases. Indeed, it should be appreciated that the examples of the e-commerce application 220 and credit check service 238 is one of potentially limitless examples of the use of such functionality, where an agent can be provided with business exception and/or risk analysis logic to easily and seamlessly add specialized logic to a system composed, for example, of composite software components or components that are not amenable to easy replacement or reprogramming. Such systems can include email systems, social networking systems, government systems, search engines, web-based media systems, testing systems, among potentially countless others.

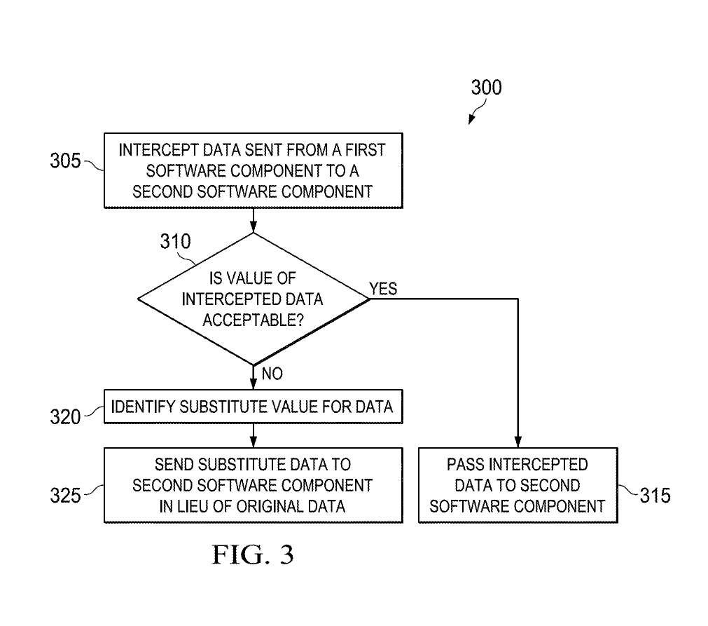

FIG. 3 is a flowchart 300 illustrating steps of an example technique for using instrumentation agents to modify software component messages to realize, for example, some of the benefits, goals, results, features, and/or functionality described above. Data sent between a first and second software component can be monitored by an instrumentation agent. The agent can intercept 305 data sent from the first component to the second component. The agent can analyze the intercepted data before allowing it to proceed to the second component and be acted upon the second component to determine 310 if one or more values of the intercepted data are acceptable. Whether the data values are acceptable or not can be based on a number of factors, determined by the particular logic of the agent employed to monitor messaging, communications, and/or transactions between the particular first software component and one or more other software components. Indeed, the logic of the agent can depend, at least in part, on the features, identity, role, and functionality of the software components involved in the messages intercepted 305 by the agent. Further, determining 310 whether a particular intercepted value is acceptable can also be based on the context of the intercepted data. For instance, in some contexts, data with a particular value sent between a first component and a second component, for processing by the second component, can be acceptable in some instances or contexts, but be found unacceptable in others, such as in the example of risk analyses or exception modeling. Returning, for simplicity, to the credit check service example discussed above, an error or outage message sent from a credit check service 238 to an OMS 225 can be acceptable for certain customers, purchases (e.g., purchases below a certain dollar amount), etc., and unacceptable under others (e.g., where the customer is a first-time purchaser, etc.). Other examples and functionality fall within these concepts, such as the consideration of other contexts, including an amount of traffic handled by a particular software component, the time the data was intercepted, whether similar data had been previously intercepted and acted upon (either passed or modified) within a particular period, among many other examples.

Continuing with the example of FIG. 3, if it is determined 310 that a particular value of the intercepted data is acceptable, the agent can then allow the data to pass 315 to the second software component. This can involve the agent forwarding the intercepted data, for instance, in total or as-is, directly from the agent to the second software component, rather than directly from the first software component. In some instances, the agent can be in communication with, integrated with, interface with, or otherwise be associated with one or the other of the first and second software components so that the interception and passing of data from the agent to the second software component appears, to the second software component, to actually originate from the first software component so as to protect against the second software component rejecting the data passed from the agent.

In instances where the agent determines 310 that the value of the intercepted data is unacceptable, the agent can identify 320 a substitute value for the intercepted value that is more acceptable that the original value of the intercepted data. Data with the substitute data can then be sent 325 to the second software component in lieu of data having the original value. A substitute value for intercepted data can be determined, generated, or otherwise identified 320 in an attempt to provide an input to the second software component that would generate a different result at the second component than would have been generated in response to receipt of the original data. Accordingly, agent logic can account for the internal logic of the second software component in identifying 320 a substitute value of intercepted data. In some instances, a substitute value can be identified or generated based on a model of one or more transactions involving at least the first and second software components. For instance, through the observation of interactions, communications, messaging, and transactions between the first and second software components, models can be generated and particular substitute data values can be identified (based on prior observed transactions and results) that can be adopted by the agent to effect similar results or processes. For instance, based on previously-observed messaging or transactions under conditions similar to those detected by the agent during monitoring and intercepting of data between the first and second software components, an agent can identify substitute data with values similar to those observed in the previous successful transactions. A rich variety of logic and algorithms can thus be applied within a variety of agents depending on the purpose of the agent as well as the software components monitored using the agent, including techniques and principles discussed above.

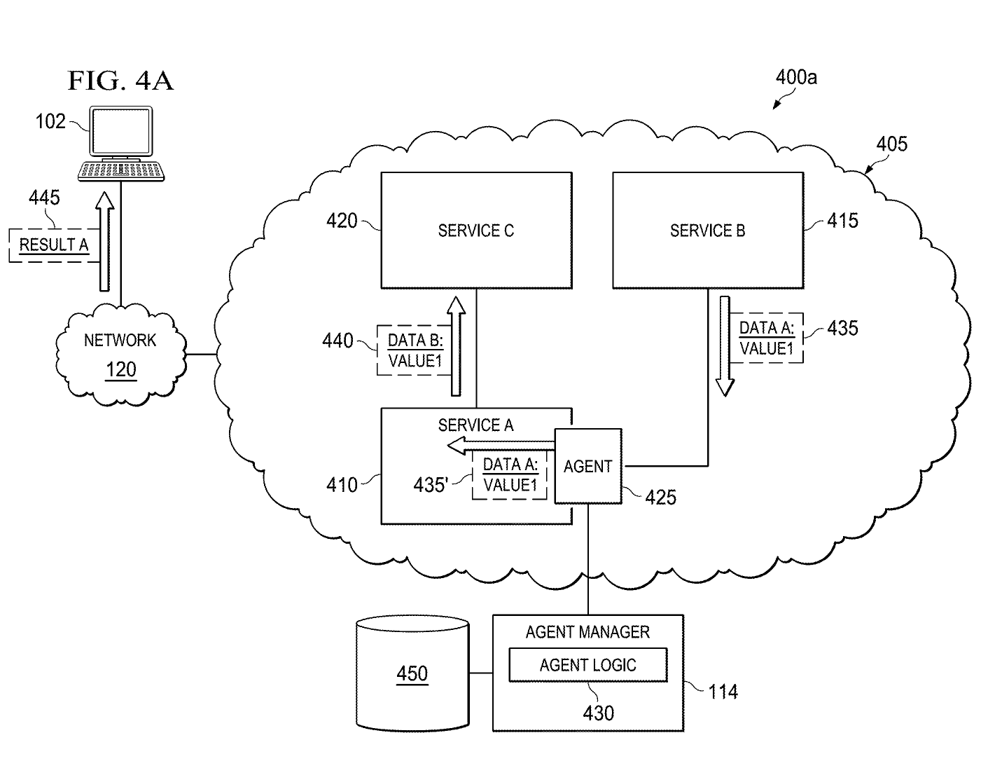

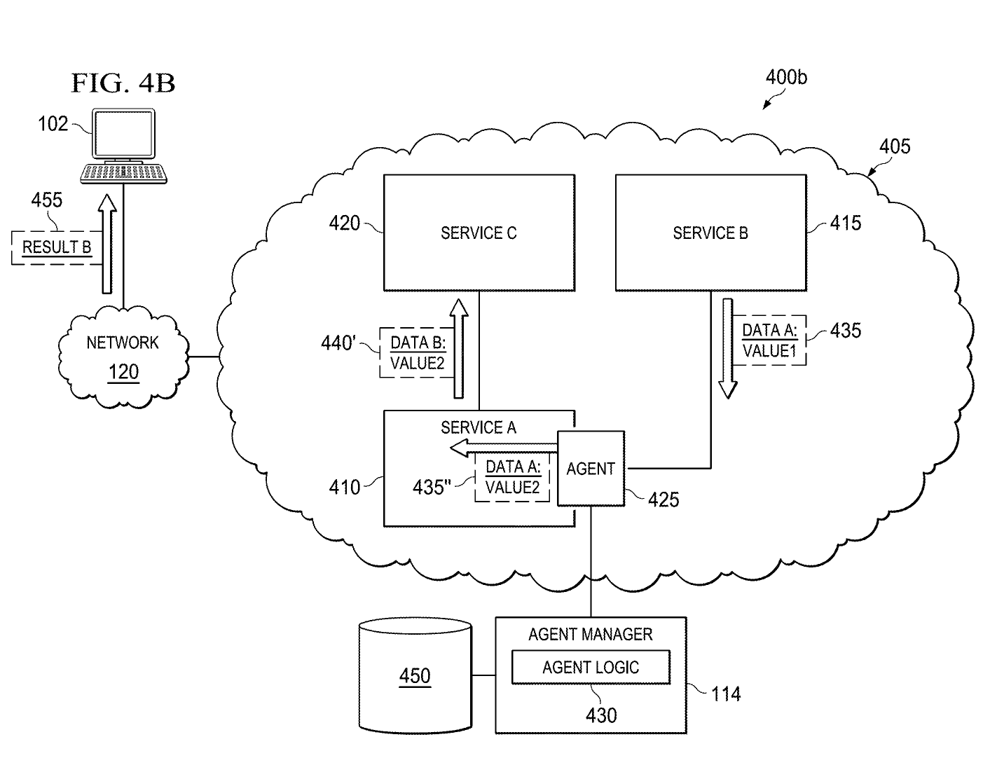

FIGS. 4A-4B illustrate representations 400a-b of example uses of instrumentation agents to modify incoming software component responses. As shown in the example of FIG. 4A, an application or service 405 can make use of a plurality of different software components (e.g., 410, 415, 420) operating cooperatively within a composite software system. The application or service 405 can be consumed by one or more clients (e.g., 102), for instance, remotely using one or more networks 120. In one example, one or more software components (e.g., 410) can have an embedded or interfacing instrumentation agent (e.g., 425) operating in connection with the software component. In the example of FIG. 4A, agent 425 is embedded in software component A 410 and makes use of logic to intercept messages received from one or more other software components (e.g., 415, 420) capable of communicating (or operating cooperatively) with the software component 410. In some examples, an agent can be dedicated to monitoring, intercepting, analyzing, and modifying messages and data sent from a particular software component (e.g., 415) or set of software components. In instances where a single software component is reused across multiple composite applications, an agent can also be configured to be adapted to a particular composite application or service including the software component. Indeed, a single software component can include a plurality of different agents, each dedicated to a particular function, transaction, use case, etc. In other instances, a single agent can be tasked with handling a wide (or the full) array of messaging, transactions, interactions, and use cases of the corresponding software component in which it is embedded.

Continuing with the example of FIG. 4A, data 435 can be sent from software component B 415 destined for at least software component A 410 and for use by software component A 410. An agent 425 can intercept data 435 before it is acted upon (or even received) by software component A 410. The agent 425 can make use of logic 430 provided and/or generated, for example, by an agent manager 114, to analyze intercepted data 435 and determine whether, and under what conditions, the intercepted data 435 should be allowed to pass to software component A 410 (with its present values). Agent 425 can also use logic 430 to determine when (and how) the values of the intercepted data should be modified by the agent 425 to realize a particular goal, response, or output by software component A 410 acting on data received from software component B 415.

In the example of FIG. 4A, agent 425 analyzes data 435 and determines that the data 435 should be allowed to pass to software component A 410 at least substantially as-is (e.g., as data 435′). Software component A 410 can then act on data 435′ and generate response data 440 based at least in part on the values of data 435′. Software component A 410 can, in turn, pass result data 440 downstream to other software components (e.g., software component C 420). In the aggregate, the value of data 435 from software component B 415 and acted upon by software component A 410 can affect the results, values, and outputs (e.g., 445) of composite service 405 as served to and consumed by clients (e.g., 102). For instance, as shown in the example of FIG. 4A, a first result or output 445 can result be based, at least in part, on the processing of data 435′ by software component A.

Service 405 can generate different outputs and results based on the values of data processed by software component A 410, as well as other factors and software components in service 405. In one example, as shown in the example of FIG. 4B, agent 425 can receive data 435 and determine that one or more values of data 435 are unacceptable (e.g., under particular conditions, or using different logic 430). Further, agent 425 (e.g., using logic 430 provided by agent manager 114) can identify or generate one or more substitute values for data 435 and modify data 435 (to generate 435″) before allowing software component A 410 to act on the data. In such an instance, it can appear to software component A 410 that data 435″, as modified by agent 425, is an unmodified output of software component B 415. Accordingly software component A 410 can act upon the modified data 435″ to generate one or more results.

In some instances, the modifications to data 435″ can result in software component A 410 processing the data 435″ to return a result different from what would have resulted had software component A 410 processed the data as originally sent from software component 415 (i.e., data 435′ of example FIG. 4A). Indeed, in the example of FIG. 4B, data 440′ output from software component A 410 has a value different from the data 440 returned by software component A 410 in the example of FIG. 4A. Additionally, in this particular example, the effect of the modifications of agent 425 on data 435 can be perpetuated throughout service 405 to result in a different result or output 455 returned from the service 405 itself, as shown in FIG. 4B.

As the actions of a single agent embedded within a single software component can affect the output of the greater, composite system (e.g., 405), it can be useful to provide accounting options to understand when and how particular agents have intervened during the course of a system's functioning within a live production environment to affect the output of the system. Accordingly, an agent (e.g., 425) can generate data outlining transactions monitored, messages intercepted, and modification made, including context data, metadata, and other data describing the conditions of the agent's intervention in a transaction. For instance, in response to detecting a request, response, and/or other activity to be monitored at the corresponding software component, agents can be configured to detect one or more characteristics associated with that activity and/or the monitoring of that activity by the agent. Such characteristics can be embedded in messages (or “frames”) sent from the agent to an agent manager (e.g., 114) that can include, for example, a frame identifier, which identifies a particular message sent by the agent to the agent manager; a parent identifier, which identifies the software component or other source of data sent to the component or sub-component and monitored (and/or intercepted) by the agent; a transaction identifier, identifying the transaction, with respect to the component or sub-component being monitored; and an agent identifier that identifies the particular agent, with respect to other instrumentation agents in the software environment or system, that is generating the frame.

A frame generated and sent by an agent to agent manager 114 can report substitute data generated and modifications made by the agent to data intercepted during a transaction. Further, characteristics of the transaction can be captured and calculated by the agent, including a system clock value, current processor and/or memory usage, contents of the request, contents of the response to the request, identity of the requester that generated the request, identity of the responder generating the response to the request, Java virtual machine (JVM) statistics, standard query language (SQL) queries (SQLs), number of database rows returned in a response, logging information (e.g., messages logged in response to a request and/or response), error messages, simple object access protocol (SOAP) requests, values generated by the component that includes the instrumentation agent but that are not returned in the response to the request, web service invocations, EJB method invocations, EJB entity lifecycle events, heap sizing, among other examples. Characteristics can also include the thread name of a thread processing the request to generate the response, the class name of the class of an object invoked to process the request to generate the response, a Web Service signature used to contain the request and/or response, arguments provided as part of the request and/or response, a session identifier, an ordinal (e.g., relating to an order within a transaction), the duration of time spent processing the request and/or generating the response, state information, a local Internet Protocol (IP) address, a local port, a remote IP address, a remote port, among other examples.

Characteristic and reporting information can include information generated by the agent itself and information generated and/or processed by the component or sub-component monitored by the agent, as well as information included in data and messages intercepted by the agent. In some embodiments, each agent collects information to form a message, also referred to herein as a frame, which describes characteristics associated with a particular transaction involving the monitored software component. In such embodiments, instead of simply monitoring the performance of a single component and aggregating information about that component over a multitude of transactions, agents can provide characteristics that are specific to and correlated with specific transactions. More particularly, characteristics captured and reported by an agent can be specific to and correlated with particular messages or data monitored, intercepted, and/or analyzed by the agent in connection with a particular transaction.

The agent manager can store (e.g., in data store 450), manage, process, or otherwise use information included in received frames to generate reporting data for use by administrators and other users to monitor the use and functionality of one or more agents within one or more systems. In some implementations, agents can communicate with agent managers (e.g., 114) via a messaging system such as Java™ Message Service (JMS). Additionally, agent managers can create a messaging system topic for each transaction (referred to herein as a transaction frame (TF) topic) and subscribe to that TF topic. Accordingly, agents (e.g., 425), upon startup, can broadcast their existence to each other and/or one or more agent managers (e.g., 114). In certain instances, agents can receive one or more TF topic from agent managers and begin publishing messages onto a message bus on that TF topic. An agent manager can then monitor the published messages and determines whether those messages relate to the current TF topic. Agents can alternatively communicate with agent managers using techniques other than those involving messaging systems. As but one example, agents can write information to databases (e.g., at 450) using database commands, and agent manager 114 can monitor those database commands to detect new information.

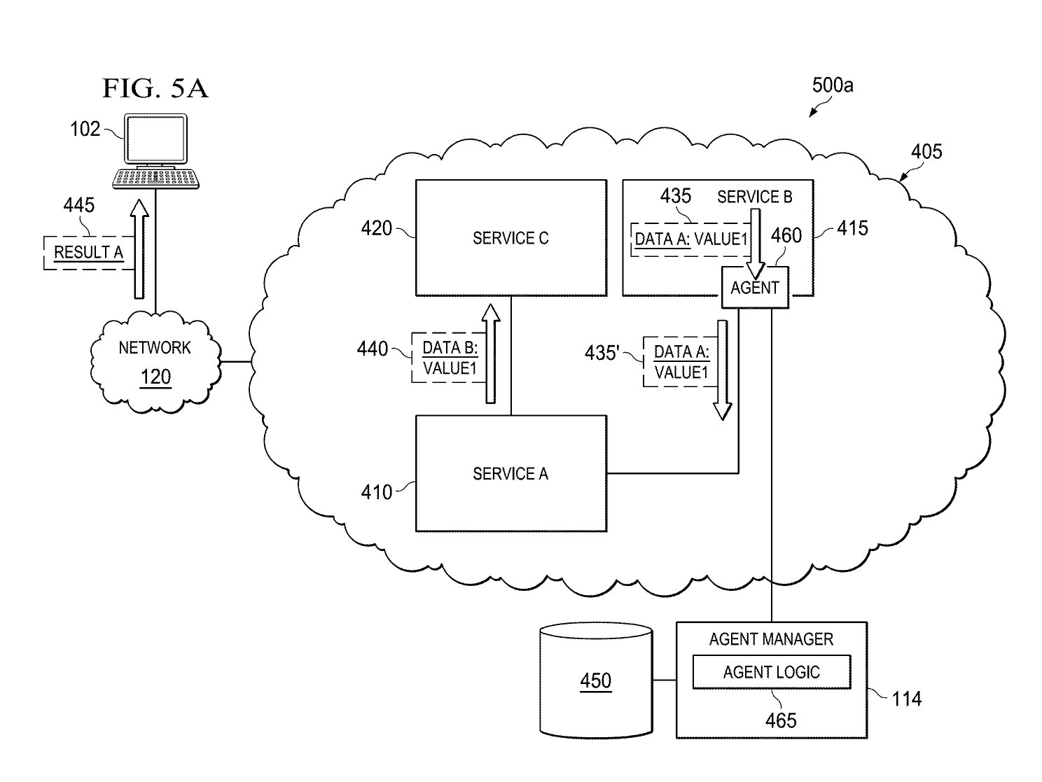

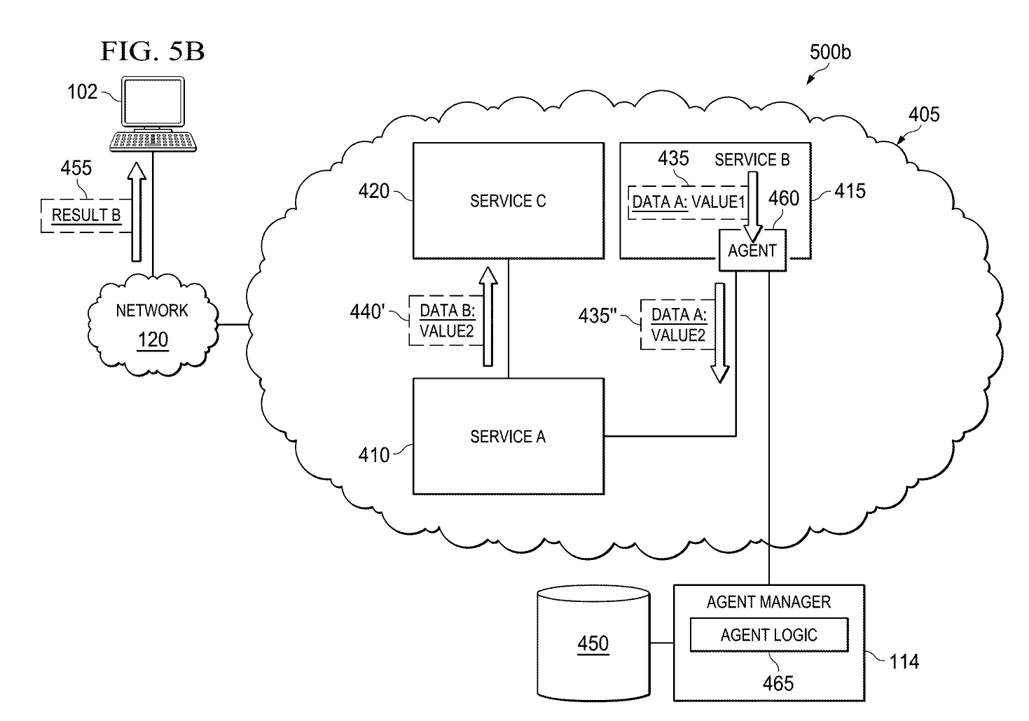

While the examples of FIGS. 4A-4B illustrated the use of agents intercepting messages sent from other software components (i.e., at the receiving software component), FIGS. 5A-5B illustrate representations 500a-b of other examples of using instrumentation agents to modify outgoing software component responses. For instance, as shown in FIG. 5A, an agent 460 can be embedded in software component B 415 to monitor data output by software component B 415 and destined for use by other downstream software components in service 405 (e.g., software component A 410). In this implementation, agent 460 inspects outputs of a software component (e.g., 415) prior to the output being passed to one or more other software components in a system. For example, as shown in FIG. 5A, agent 460 can inspect data 435, prepared by software component B 415 for forwarding to software component A 410. Before the data 435 is sent, agent 460, added to and supplementing the functionality of software component B 415, can inspect the data 435 to determine whether data 435 with these values should be passed to, and potentially used by, software component A 410. In this particular example, agent 460 can make use of agent logic 465 to determine that the data 435 is acceptable to send, passing data 435′ to software component A 410 for use by software component A 410, the value of the passed data 435′ substantially the same as the value of the data original generated by software component 415.

As in the examples of FIGS. 4A-4B, the values of data 435 (and 435′) can affect downstream results (e.g., 440) of the receiving software component (e.g., 410, 420) as well as the results (e.g., 445) of the service (e.g., 405) itself. Turning to FIG. 5B, agent 460 can also intercept data 435 before it is sent to downstream software components or sub-components and determine that data 435 should not be passed as-is. Further, agent 460 can identify or generate a substitute value for the data 435 and pass substitute data 435″ to software component A in lieu of the original data 435, based on the determination. As in other examples, logic 465 can be used to determine whether intercepted data (e.g., 435) is acceptable within a certain context, according to certain rules, or under certain conditions. Logic 465 provided to the agent 460 can also be used to generate substitute data values appropriate to the observed conditions or context.

In some implementations, logic 465 can be based on or consult pre-generated models of interactions between two or more software components or sub-components. The models can be generated, for example, from pre-observed and pre-captured messaging between the software components, as well as from responses of the components, and the system itself, to outputs of software component B 415. In certain instances, the very agents used to intervene in live transactions between software components, such as described in examples above, can also be used to perform the monitoring and observation of the software components and transactions serving as the basis of the model. Additionally, data intercepted by an agent can also be used to adjust and optimize a preexisting model upon which agent logic (e.g., 430, 465) can be based. Agents (e.g., 425, 460) can identify or generate substitute values for data, from the models, based on pre-observed data values that led to one or more desired outcomes and attempt to reconstruct these outcomes by modifying intercepted data to pass data that more closely mimics the desirable, pre-observed data and behaviors.

For instance, returning, for purposes of simplicity, to the credit check software component example discussed earlier, operation, interactions, transactions, and messaging of a composite e-commerce application can be observed to develop a model of the e-commerce application. Further, the model can indicate that a positive credit check result, returned from a credit check software component used in the e-commerce application, can assist in permitting the completion of related retail transactions using the e-commerce application. Accordingly, in response to determining that a particular intercepted output of the credit check software component is undesirable (given particular conditions, or particular calculated risks), the agent can identify a substitute value for the intercepted data by consulting the generated model. For instance, the agent can identify a substitute value from the model that resulted in a retail transaction being completed. Further, the agent can also identify from the model that the output intercepted from the credit check software component would result in a particular retail transaction being cancelled, leading to the determination to generate a substitute value for the intercepted data, among many other examples. Such a model could then be used, by agents at either the receiving software component (e.g., agent 425) or the sending software component (e.g., agent 460), to generate or otherwise identify data values that are amenable to effect a particular result at either the software component or system level.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, agent, module, (software) tools, (software) engines, or code) can be written in any form of programming language, including compiled or interpreted languages, declarative or procedural languages, and it can be deployed in any form, including as a standalone program or as an agent, module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems (e.g., system 100) may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, that are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system (e.g., 100). A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A method comprising:
intercepting, using a first agent, first data sent to a first software component from a second software component in a transaction, each of the first and second software components included in a plurality of software components included in a particular software system, wherein the first data corresponds to a response by the second software component to a request by the first software component in the transaction;
determining, at the first agent, that a particular value of the intercepted first data is different from one or more preferred values for the first data that allow the transaction to be completed successfully;
responsive to determining that the particular value of the intercepted first data is different from the one or more preferred values, determining a risk associated with passing the intercepted first data with the particular value rather than with one of the preferred values;
determining substitute first data corresponding to a particular one of a plurality of monitored previous interactions between the first and second software components, wherein the substitute first data includes a preferred value; and
passing the substitute first data to the first software component instead of the intercepted first data based at least in part on the risk.

2. The method of claim 1, wherein the first data is intercepted during live operation of the particular software system.

3. The method of claim 1, wherein the transaction comprises a live e-commerce transaction.

4. The method of claim 1, wherein the first agent interfaces with the first software component and intercepts the first data before the first data is received by the first software component.

5. The method of claim 1, wherein the first agent interfaces with the second software component and intercepts the first data before the first data is sent to the first software component from the second software component.

6. The method of claim 1, wherein the first software component uses the substitute first data to generate a response included in the transaction.

7. The method of claim 1, wherein the particular software system is a composite software system and the first software component is an element of a first software system and the second software component is an element of a distinct, second software system.

8. The method of claim 1, further comprising generating the substitute first data at the first agent in response to determining that the particular value is different from the one or more preferred values.

9. (canceled)

10. The method of claim 1, wherein the first software component generates a first result in response to the first data having the particular value and generates a second, different result in response to the substitute first data.

11. The method of claim 1, wherein determining that the particular value is different from the one or more preferred values includes determining that the particular value corresponds to an error message.

12. The method of claim 1, wherein determining the risk comprises:
assessing benefits of replacing the intercepted first data with the substitute first data against risk associated with replacing the intercepted first data; and
assessing risk of allowing the transaction to potentially fail based on allowing the first data to be passed with the particular value.

13. The method of claim 1, wherein the risk is associated with a business scenario potentially affected by allowing the first data with the particular value.

14. The method of claim 1, further comprising using the first agent to log the interception of first data with the particular value.

15. The method of claim 1, further comprising using the first agent to log the passing of the substitute first data in lieu of the intercepted first data.

16. The method of claim 1, further comprising:
intercepting, using the first agent, second data sent to the first software component from the second software component;
determining, at the first agent, that a value of the intercepted second data conforms to one or more preferred values for the second data; and
passing the intercepted second data to the first software component for use by the first software component.

17. An article comprising non-transitory, machine-readable media storing instructions operable to cause at least one processor to perform operations comprising:
intercepting, using a first agent, particular data sent to a first software component from a second software component in a transaction, wherein each of the first and second software components is included in a plurality of software components included in a particular software system, and the first data corresponds to a response by the second software component to a request by the first software component in the transaction;
determining, at the first agent, that a particular value of the intercepted particular data is different from one or more preferred values for the particular data that allow the transaction to be completed successfully;
responsive to determining that the particular value of the intercepted first data is different from the one or more preferred values, determining a risk associated with passing the intercepted particular data with the particular value rather than with one of the preferred values;
determining substitute first data corresponding to a particular one of a plurality of monitored previous interactions between the first and second software components, wherein the substitute first data includes a preferred value; and
passing the substitute first data to the first software component instead of the intercepted particular data based at least in part on the risk.

18. A system comprising:
a memory element storing data;
a processor operable to execute instructions associated with the stored data;
at least one first software component interacting with at least one other software component in a software system; and
at least one agent configured to:
intercept particular data sent to the first software component from at least one other software component in a transaction, wherein the transaction comprises a request from the first software component to the other software component and a response to the request by the other software component, and the particular data corresponds to the response;
determine that a particular value of the intercepted particular data is different from one or more preferred values for the particular data that allow the transaction to be completed successfully;
responsive to determining that the particular value of the intercepted first data is different from the one or more preferred values, determine a risk associated with passing the intercepted particular data with the particular value rather than with one of the preferred values;
determine substitute first data corresponding to a particular one of a plurality of monitored previous interactions between the first and second software components, wherein the substitute first data includes a preferred value; and
pass the substitute first data to the first software component instead of the intercepted particular data based at least in part on the risk.

19. The system of claim 18, wherein the software system serves a composite application using the first software component and at least one other software component.

20. The system of claim 18, wherein the particular data is sent to the first software component from at least one other software component in connection with the delivery of a service to a customer.

21. The method of claim 1, wherein the particular value of the intercepted particular data corresponds to a failed transaction and the substitute first data corresponds to a previous successful transaction.
